(19) United States
(12) Patent Application Publication
(10) Pub. No.: US 2023/0026875 A1
(43) Pub. Date: Jan. 26, 2023

(54) Method And Apparatus for High Accuracy Geodetic Survey Using GNSS Signals

(71) Applicants: Pavel Igorevich Ignatiev, Tokarevo (RU); Vasiliy Mikhaylovich Dmitriev, Balashikha (RU); Sergey Vladislavovich Averin, Obninsk (RU); Viacheslav Viktorovich Lanovets, Moscow (RU)

(72) Inventors: Pavel Igorevich Ignatiev, Tokarevo (RU); Vasiliy Mikhaylovich Dmitriev, Balashikha (RU); Sergey Vladislavovich Averin, Obninsk (RU); Viacheslav Viktorovich Lanovets, Moscow (RU)

(21) Appl. No.: 17/436,606

(22) PCT Filed: Mar. 2, 2021
(86) PCT No.: PCT/RU2021/000089

§ 371 Date: Sep. 5, 2021

(51) Int. Cl. G01S 19/39; G01S 19/28; G01S 19/29; G01S 19/44

(52) U.S. Cl. CPC G01S 19/396; G01S 19/28; G01S 19/29; G01S 19/44

(57) ABSTRACT

An apparatus for surveying a position of a static point, consisting of a GNSS receiver and a mobile computing device, connected with GNSS receiver via communication interface. The mobile computing device accepts from GNSS receiver several estimations of position of a static point within a single session and computes combined result for the current session, which is the average of those estimations. After that, a reset command is send to a GNSS receiver, and another session is performed in order to get another combined result. The process continues until a required number of mutually consistent session results is collected, where ‘consistent’ means having the scatter of session results within a certain margin. Upon collecting the required number of consistent session results, they are combined to compute a single estimate of the position of a static point, which is considered as a result of survey.

### BACKGROUND OF THE INVENTION

### Field of the Invention

The present invention relates generally to global navigation satellite systems (GNSS), and more particularly, to a method and apparatus providing survey of static locations with the highest precision and reliability.

### Background of the Related Art

The equipment that receives signals of global navigation satellite systems (GNSSs) can determine target parameters, such as position, velocity, time (PVT). Examples of currently deployed global navigation satellite systems include Global Positioning System (GPS) of the United States of America and the GLONASS of Russian Federation. Other global navigation satellite systems, such as the European GALILEO and the Chinese BEIDOU, are under development. In a GNSS, a navigation receiver receives and processes radio signals transmitted by satellites located within a line-of-sight of the receiver. The satellite signals comprise carrier signals modulated by pseudo-random binary codes. The receiver measures the time delays of the received signals relative to a local reference clock, or oscillator. Code phase measurements enable the receiver to determine the pseudo-ranges between the receiver and the satellites. The pseudo-ranges differ from the actual ranges (distances) between the receiver and the satellites due to an offset, caused by the shift between the time scales of the GNSS and the receiver.

Measured pseudo-ranges along with other parameters measured by receiver are referred to as raw measurement data. If signals are received from a sufficiently large number of satellites, then the measured pseudo-ranges can be processed to determine the coordinates and the offset caused by the shift between the time scales of the GNSS and the receiver. This operational mode is referred to as a stand-alone mode since the measurements are determined by a single receiver. A stand-alone system typically provides a position accuracy of about a meter.

To improve the position accuracy, differential navigation (DN) systems have been developed. In a DN system, the position of a user is determined relative to a base station, also referred to as a base. The base is typically fixed, and the coordinates of the base are precisely known, for example, by surveying. The base contains a navigation receiver that receives satellite signals and that can compute the corrections to GNSS measurements based on the known base position. In some DN systems, the raw measurement data of the base can serve as corrections.

The user, whose position is to be determined, can be stationary or mobile. In a DN system, the user is often referred to as a rover. The rover also contains a navigation receiver that receives GNSS satellite signals. Corrections generated at the base are transmitted to the rover via a communications link. To accommodate a mobile rover, the communications link is often a wireless link. The rover processes the corrections received from the base, along with measurements taken with its own receiver, to improve the accuracy of determining its position.

Accuracy is improved in the differential navigation mode because errors incurred by the receiver at the rover and by the receiver at the base are highly correlated. Since the coordinates of the base are accurately known, measurements from the base can be used for calculating corrections, thus compensating for the errors at the rover. If a DN system generates corrections to pseudo-ranges measured with code phase only, such a DN system is capable to provide a position accuracy on the order of tens of centimeters.

The position accuracy achieved with data generated by a DN system can be further improved, if a DN system, in addition to corrections based on pseudo-ranges measured with code phase, generates corrections based on pseudo-ranges measured with carrier phase. Carrier phase measurements along with code phase measurements are a part of raw measurement data, generated by the receiver. Improvement in positioning accuracy is achieved because pseudo-ranges measured with carrier phase have ˜100 times smaller noise and multipath measurement errors, compared with pseudo-ranges measured with code phase. A differential navigation system that computes positions based on real-time carrier phase pseudo-range measurements, in addition to the code phase pseudo-range measurements, is often referred to as a real-time kinematic (RTK) system.

As a result of a DN system operation, the position of a rover is determined with an improved accuracy, but this accuracy is relative, and depends on accuracy of the base position. So, any offset of the known base position from the truth will translate into the same offset of a rover position. In other words, components of the “base-to-rover” vector can be determined accurately in a given reference frame, and then, these components should be applied to base position (not necessarily accurate) in order to compute position of the rover.

Among applications of RTK systems are highly accurate measurements of coordinates of static points. This mode of RTK operation is often referred to as topographic or geodetic survey, and points, which are to be surveyed with the highest accuracy, are often referred to as checkpoints. When in the geodetic survey mode, an antenna of a rover receiver is positioned on a checkpoint for some time, and several RTK solutions are computed. These RTK solutions should be averaged or filtered to provide the most accurate evaluation of coordinates of a checkpoint.

This approach is described in, for example, in Ulrich et al., WO 2010/096190 A2, entitled “GNSS Surveying Methods and Apparatus”.

The process of surveying a static point via processing several sequential GNSS solutions is often referred to as “occupation”. The same point might be surveyed with several occupations that is visiting it for some time in different periods, separated with some intervals. Surveying the same point with several occupations helps to improve the robustness of results due to randomization of measurement errors, which might have correlation in time.

Processing carrier phase measurements to determine coordinates in RTK system includes the step of ambiguity resolution (AR); that is, determining the integer number of cycles in the measured carrier phase pseudo-ranges.

A process of AR is probabilistic. This means there is always a non-zero probability of incorrect AR, which could lead to inaccurate positioning results.

The problem of incorrect AR becomes much more severe if a user is to perform a geodetic survey in challenging conditions, like an urban canyon, or tree canopy, i.e., when GNSS signals are partially blocked or distorted because of re-radiation from various structures. In such conditions, RTK solutions might be erroneously shifted from the true values due to incorrect AR, thus generating erroneous evaluation of a point coordinates, where “erroneous” means that the actual accuracy of evaluated coordinates is worse than estimated accuracy.

The solution computed as result of incorrect AR is often referred to as “outlying solution”, or “outlier” for short.

The main problem with outliers is that estimated accuracy of such a solution is overly optimistic. As such, when performing geodetic survey, a task is twofold:
to exclude outliers while evaluating point coordinates;
to compute trustworthy accuracy estimation for evaluated coordinates.

Completion of this task is the responsibility of RTK algorithm of the rover. One of the approaches is described in Milyutin et al., U.S. Pat. No. 9,891,325 B2, entitled “Detection and Correction of Anomalous Measurements and Ambiguity Resolution in a Global Navigation Satellite System Receiver”.

However, in challenging environments, it might be hard for RTK algorithm to detect and compensate for outliers due to deficient satellite geometry, or increased error levels, and methods of external control of solution quality should be applied.

In France et al., US patent publication no. 20100225532 A1, entitled “Outlier Detection by Cross-Comparison of Different Position Solution Types”, the suggestion is made to compute solutions of different types for a single epoch (e.g., RTK fix plus Stand-alone, or RTK L1 fix plus RTK L1/L2 fix), and to compare the difference of these solutions with a certain threshold. Based on comparison results a decision should be made, what solution type is more accurate and what is the actual positioning accuracy.

In Liu et al., U.S. Pat. No. 7,498,979 B2, entitled “Fast Decimeter-level GNSS Positioning”, a method is descried of how, in real time to predict the positioning accuracy, achieved in post-processing. To achieve this goal a Post-Processing Accuracy (PPA) predictor is used. The purpose of PPA is to timely inform an operator who collects data, that he might stop data collection, as the data size and the quality are enough to guarantee a predefined level of positioning accuracy while post-processing. As it follows from the header of the patent, the idea relates to positioning with not so high accuracy, and no AR is attempted to achieve higher accuracy.

In Vollath et al., U.S. Pat. No. 7,982,667 B2, entitled “Post-Processed Accuracy Prediction for GNSS Positioning”, the Stochastic Post-Processed Accuracy (SPPA) predictor is described which serves the same purpose of informing an operator of the moment when he needs to stop data collection, if the size of the data is sufficient to provide the needed level of positioning accuracy while post-processing. The idea of SPPA is identical to that of PPA, and the difference between implementations is in slightly different set of factors to be taken into account. The same as PPA, the SPPA relates to positioning with decimeter level of accuracy, as no AR is involved.

In Vollath et al., U.S. Pat. No. 9,116,231 B2, entitled “Indicating Quality of GNSS Position Fixes”, a method is described for evaluating a solution quality based on various parameters like, number of measurements, expected measurement accuracy, GNSS satellite geometry, signal-to-noise ratios, etc. Evaluated solution quality is opposed to availability, i.e., an operator might select between two, or choose “balanced” mode, when generating a positioning solution.

The subject of the invention herein is a method and an apparatus, which are external to a roving GNSS receiver with its intrinsic RTK algorithm. These method and apparatus are aimed at analysis of static solutions of a single occupation, with the purpose of generating the most accurate solution for this occupation. These method and apparatus are different from what is known in prior art due to:
being purposed for real time operation in the field, not for post-processing, though the method can be used in post-processing as well;
analyzing solutions of the same type, primarily RTK fixed, to generate the most precise and robust evaluation of point's position;
applying the analysis to sequentially acquired solutions, i.e., solutions of a single occupation.

With the invention described herein, an operator is capable to see the survey results and survey estimated accuracy immediately, during the survey. As such, in the process of the survey, an operator is capable to decide, how long this occupation should be in order to survey the checkpoint without outliers, and avoid visiting it with new occupations.

### SUMMARY OF THE INVENTION

Accordingly, the present invention is directed to a highly accurate and robust determination of position of a static point using a Global Navigation Satellite Systems (GNSS) receiver. A method and apparatus for processing in a specific way position estimates, outputted by the GNSS receiver, is provided. The method and apparatus are intended for real-time operation and are suitable for processing the solutions of the highest accuracy: of “RTK fixed” type, computed with all available signals of all available GNSS. As such, this method and apparatus substantially obviate one or more of the disadvantages of the related art.

In one aspect, there is provided a method for surveying a position of a static point with use of GNSS receiver. The method includes, but is not limited to the following steps: (i) accepting from GNSS receiver two, or more estimations of position of a static point, where the process of accepting a series of these estimations is called session hereinafter; (ii) combining estimations, computed in (i) into a single estimation of position of a static point, where a combined estimation is called session result hereinafter; (iii) resetting a GNSS receiver what includes, but is not limited to resetting tracking loops for all or selected satellites, resetting tracking loops for all or selected frequencies, resetting filters or smoothing loops in positioning algorithms; (iv) repeating (i)-(iii) two times as minimum; (v) checking results of several sessions for consistency, that is having their scatter within specified margins; (vi) upon finding a required number of consistent session results, which is, minimum two, combining them into a single position estimation of a static point; (vii) upon inability to find a required number of consistent session results, repeating (i)-(vi) until a required number of consistent session results is found.

Optionally, the method terminates if the required number of consistent session results is not found after a predefined number of attempts, and an alerting message is issued to a customer. Optionally, the method includes a check for consistency of estimations, performed prior (ii), allowing only consistent estimations to be combined into session result. Optionally, the method terminates if the required number of consistent estimations is not found prior (ii), and an alerting message is issued to a customer. Optionally, combining estimations in (ii) is performed as averaging with weights. Optionally, combining session results in (vi) is performed as averaging with weights. Optionally, the suggested method is applied to estimations of position of a static point, computed in real-time kinematics (RTK) mode, outputted by GNSS receiver.

In another aspect, there is provided an apparatus, built for the purpose of surveying a position of a static point, consisting of, but not limited to a GNSS receiver and a mobile computing device, connected with GNSS receiver via communication interface. The mobile computing device: (i) accepts from GNSS receiver two, or more estimations of position of a static point, where the process of accepting a series of these estimations is called session hereinafter; (ii) combines estimations, computed in (i) into a single estimation of position of a static point, where a combined estimation is called session result hereinafter; (iii) resets a GNSS receiver what includes, but is not limited to resetting tracking loops for all or selected satellites, resetting tracking loops for all or selected frequencies, resetting filters or smoothing loops in positioning algorithms; (iv) repeats (i)-(iii) two times as minimum; (v) checks results of several sessions for consistency, that is having their scatter within specified margins; (vi) upon finding a required number of consistent session results, which is, minimum two, combines them into a single position estimation of a static point; (vii) upon inability to find a required number of consistent session results, repeats (i)-(vi) until a required number of consistent session results is found.

Optionally, the mobile computing device is built in the form of, but is not limited to ruggedized field controller, notebook, smartphone or tablet. Optionally, the mobile computing device is run under control of, but is not limited to any of the following exemplary operating systems: WINDOWS, ANDROID, IOS, or LINUX. Optionally, the communication interface between GNSS receiver and a mobile computing device is one of the following, but is not limited to RS-232/RS-432 cable connection, USB cable connection, ETHERNET cable connection, BLUETOOTH wireless data link, or WI-FI wireless data link.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED DRAWINGS

The attached drawings that further describe the present invention are incorporated in and constitute a part of specification, illustrate embodiments of the invention and together with the description serve to explain the principles of the invention.

In the drawings:

FIG. 1A shows an example of a global navigation satellite system in which the navigation receiver operates in a stand-alone mode or in a single-base-station differential navigation mode;

FIG. 1B shows an example of a global navigation satellite system in which the navigation receiver operates in a network differential navigation (DN) mode;

FIG. 1C shows an example of a global navigation satellite system in which the navigation receiver operates in a satellite-based network differential navigation (DN) mode;

FIG. 2 shows a high-level schematic functional block diagram of an embodiment of a navigation receiver;

FIG. 3 shows a high-level schematic functional block diagram of a control and computing system implemented within a receiver;

FIG. 4 shows a high-level schematic functional block diagram of an embodiment of apparatus built for the purpose of surveying a position of a static point;

FIG. 5 shows a flow chart of an embodiment of the method for surveying a position of a static point;

FIG. 6 shows an example of how session results might scatter and form different pluralities of mutually consistent results.

### DETAILED DESCRIPTION OF EMBODIMENTS OF THE INVENTION

Reference will now be made in detail to the preferred embodiments of the present invention, examples of which are illustrated in the accompanying drawings.

The equipment that receives signals of global navigation satellite systems (GNSSs) can operate in various operational modes. Different operational modes require equipment of different complexities capable of determining target parameters (such as position, velocity, time and attitude) with different accuracies. The types and quantities of data to be processed also depend on the operational mode. Several operational modes are summarized below.

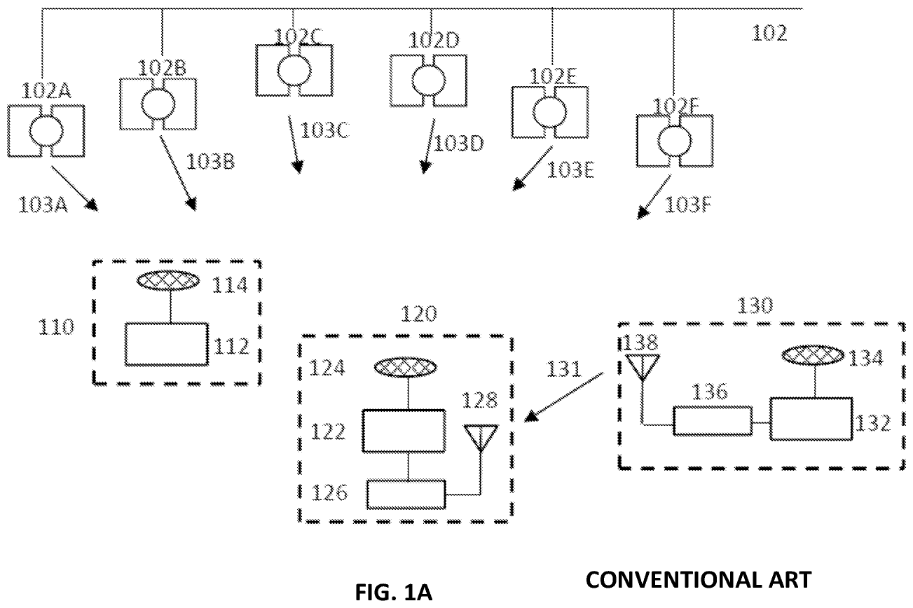

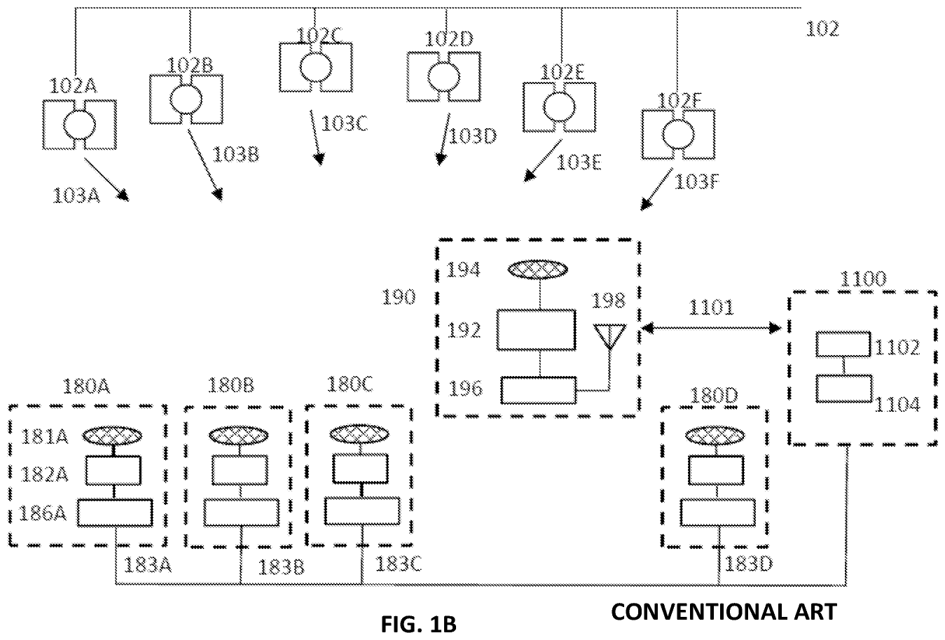

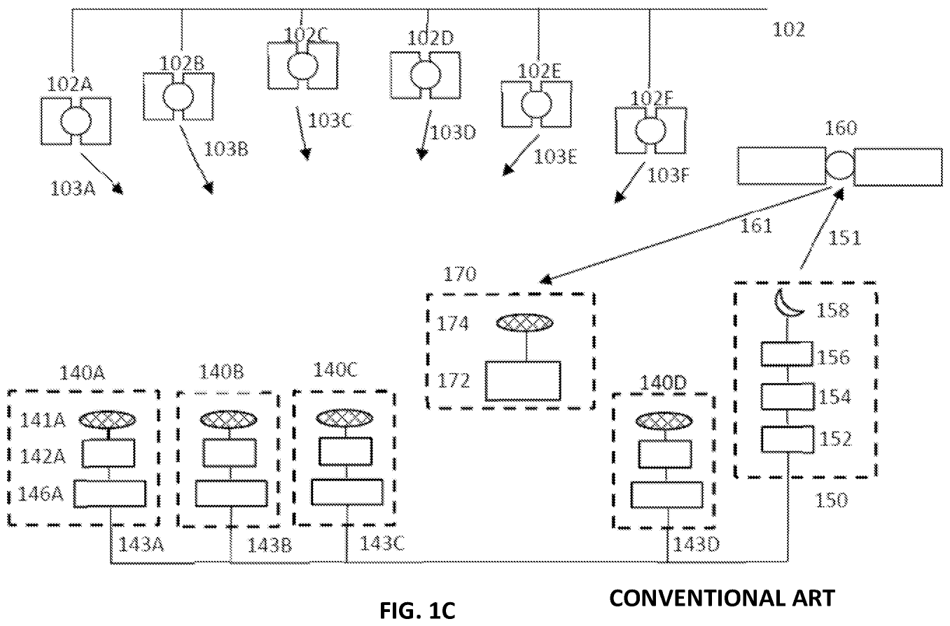

FIG. 1A shows a high-level schematic of a global navigation satellite system (GNSS). A constellation of global navigation satellites 102 transmits navigation signals. Shown are six representative navigation satellites, denoted 102A-102F, which transmit navigation signals 103A-103F, respectively. In general, the navigation satellites can belong to more than one global navigation satellite system (for example, GPS and GLONASS, or GPS, GLONASS and GALILEO).

Referring now to the GNSS measurement unit 110, which operates in a stand-alone mode, the GNSS measurement unit 110 includes an antenna 114 and a navigation receiver 112. The antenna 114 receives navigation signals, such as navigation signals 103A-103F; from these navigation signals, the navigation receiver 112 can calculate target parameters, such as time, referenced to a GNSS system clock, and position and velocity referenced to the antenna 114. In some GNSS measurement units, the antenna is mounted in a fixed relationship with respect to the navigation receiver. If the GNSS measurement unit 110 is carried by a person who is walking or running, the GNSS measurement unit 110 can be used to calculate the position and velocity of the person as a function of time. If the GNSS measurement unit 110 is mounted on a moving vehicle, the GNSS measurement unit 110 can be used to calculate the position and velocity of the vehicle as a function of time.

In other GNSS measurement units, the antenna can be moved with respect to the navigation receiver. In one application, the antenna 114 is mounted on the blade of a bulldozer, and the navigation receiver 112 is mounted inside the cab of the bulldozer; the antenna 114 is coupled to the navigation receiver 112 via a flexible cable. The GNSS measurement unit 110 can then be used to measure the position and velocity of the blade as a function of time. To simplify the discussion below, phrases such as “position of the navigation receiver” or “position and velocity of the navigation receiver” are used; strictly, however, “position” and “velocity” refer to the parameters of the antenna that receives the navigation signals that are then processed by the navigation receiver.

The navigation signals comprise carrier phase signals modulated by pseudo-random binary codes. The navigation receiver measures the time delays of the received signals relative to a local reference clock, or oscillator. Code phase measurements enable the navigation receiver to determine the pseudo-ranges, which in essence are estimates of the distances between the navigation receiver and the navigation satellites. The pseudo-ranges differ from the actual ranges (distances) between the navigation receiver and the navigation satellites due to the offset between the time scales of the navigation receiver and the respective GNSS.

If navigation signals are received from a sufficiently large number of navigation satellites, then the measured pseudo-ranges can be processed to determine the position of the navigation receiver. In general, the three-dimensional coordinates of the navigation receiver can be determined; a reference Cartesian coordinate x, y, z) system can be used. The reference Cartesian coordinate system can be an Earth Centered Earth Fixed (ECEF) system; WGS-84 is an example of an ECEF system. Two-dimensional coordinates along a reference horizontal plane (x-y plane) or a one-dimensional coordinate (z or height) along an axis normal to the reference horizontal plane can also be determined. The reference horizontal plane can, for example, be tangent to the WGS-84 ellipsoid. A time referenced to a GNSS system clock can also be calculated by the navigation receiver from the navigation signals (which contain timing information). Velocity of the navigation receiver can be calculated by taking the time derivative of position as a function of time, by processing Doppler measurements, or by processing carrier phase measurements over a specific interval of time.

Various error sources contribute to the process of measuring pseudo-ranges, thus translating to errors in determination of the position, velocity and time. Examples of error sources include satellite clock errors, satellite ephemeris errors, variations in propagation velocities of the navigation signals due to the ionosphere and troposphere, reflections of GNSS signals from the objects nearing by the antenna of navigation receiver.

Some errors can be reduced by operating the GNSS in a differential navigation (DN) mode. Refer again to FIG. 1A. The GNSS measurement unit 130, also referred to as the base station (or base) 130, is fixed or stationary; its coordinates are precisely known (for example, from high-precision surveying measurements). The GNSS measurement unit 120, also referred to as the rover 120, in general is mobile.

The base station 130 includes the antenna 134 and the navigation receiver 132. The antenna 134 receives navigation signals 103A-103F. The base station 130 also includes the communications transceiver 136 and the antenna 138. Similarly, the rover 120 includes the antenna 124 and the navigation receiver 122. The antenna 124 receives the navigation signals 103A-103F. The rover 120 also includes the communications transceiver 126 and the antenna 128. The base station 130 transmits the communications signal 131 (for example, a radio frequency signal) from the antenna 138. The rover 120 receives the communications signal 131 at the antenna 128.

From the received navigation signals, the navigation receiver 132 at the base station 130 can calculate corrections to the received GNSS measurements with respect to the known position of the base station 130. In some DN systems, raw measurement data of the base station can serve as corrections. Corrections to the received GNSS measurements, along with some auxiliary information constitute the correction data. If the distance between the base station 130 and the rover 120 is relatively small, then many of the measurement errors at the base station 130 and at the rover 120 are correlated. The base station 130 transmits correction data to the rover 120 via the communications signal 131. The rover 120 processes the navigation signals and the correction data to determine the position of the rover 120. The accuracy with which the rover 120 can determine its position in the differential navigation mode is higher than the accuracy with which the GNSS measurement unit 110 can determine its position in the stand-alone mode.

A DN system that broadcasts correction data to code phase pseudo-range measurements is often referred to as a differential global positioning system (DGPS), or a differential global navigation satellite system (DGNSS). The position determination accuracy, achieved with help of a DN system can be further improved if correction data for code phase pseudo-ranges measurements is supplemented with the correction data for carrier phase pseudo-ranges measurements.

If the carrier phases of the signals transmitted by the same satellites are measured by both the navigation receiver in the base station and the navigation receiver in the rover, processing the two sets of carrier phase measurements can yield a position accuracy to within several percent of the carrier's wavelength. A DN system, which enables positioning based on real-time carrier phase pseudo-range measurements, in addition to the code phase pseudo-range measurements, is often referred to as a real-time kinematic (RTK) system. Processing carrier phase measurements to determine position of a rover includes the step of ambiguity resolution (AR); that is, determining the integer number of cycles in the carrier phase signals received by the navigation receivers from an individual satellite.

More complex DN systems, including RTK systems, are configured as network DN systems. In a network DN system, correction data for a rover is generated from measurements collected from a group of base stations that are geographically dispersed over a wide area. A network control center processes the measurements from the group of base stations and transmits the correction data to the rover via various communications links, such as radiofrequency satellite signals or General Packet Radio Service (GPRS). Network DN systems can differ by application areas, data processing methodology and target positioning accuracy.

FIG. 1B shows an example of a regional (local) network DN system used to provide a network RTK solution; such systems are often referred to as Network RTK systems. Shown are the rover 190 and four representative base stations 180A-180D. The rover 190 includes the antenna 194 and the navigation receiver 192. The antenna 194 receives the navigation signals 103A-103F. The rover 190 also includes the communications transceiver 196 and the antenna 198. The base station 180A includes the navigation receiver 182A, the antenna 184A, and the data processing and communications unit 186A; base stations 180B-180D are each similar to the base station 180A.

In general, the rover and each base station can receive navigation signals from a slightly different subset of navigation satellites in the constellation 102 due to varying conditions in different locations. Operation of the rover in a network RTK mode is possible, however, only using satellite signals received simultaneously by the rover 190 and by the base stations 180A —180D.

Base stations 180A-180D transmit data 183A-183D, respectively, to the network control center (NCC) 1100. The data can be transmitted via communications links or via a communications network, e.g., Internet. The NCC 1100 includes the communications module 1102, and the data processing unit 1104. The NCC 1100 receives with help of communications module 1102 the data from the base stations, as well as the approximate position of the rover, and processes the data with help of data processing unit 1104, according to specific algorithms to generate a consolidated set of correction data corresponding to the rover position (described in more detail below).

The NCC 1100 makes the consolidated set of correction data available to the rover via a communications network, e.g., Internet, accessible via GPRS, for example. In FIG. 1B, the NCC 1100 receives the rover's approximate position and delivers the consolidated set of error correction data via the communications channel 1101 (for example, Internet, accessible via GPRS of cellular network). The rover 190 receives the correction data via the communication channel 1101 at the antenna 198. The rover 190 then calculates its position based on measurements collected with its receiver and the consolidated set of correction data.

The consolidated set of correction data in network RTK systems can be partitioned into several groups. The consolidated set of correction data can include:
Cumulative corrections to both code phase and carrier phase measurements from one or more individual base stations in a group of base stations;
Corrections to code phase and carrier phase measurements for some virtual (i.e., non-existent) base station generated from processing GNSS measurements collected with a group of base stations;
Corrections representing the dispersive part of GNSS measurement errors (measurement errors attributable to the ionosphere) for measurements from one or more individual base stations in a group of base stations;
Corrections representing the non-dispersive part of GNSS measurement errors (measurement errors attributable to the troposphere, satellite ephemeris, and satellite clock data) for measurements from one or more individual base stations in a group of base stations;
Coefficients approximating how various GNSS measurement error components change in space; and
Auxiliary information, such as evaluated hardware-induced biases, station ID, textual information on hardware or software of service provider, etc.

FIG. 1C shows another example of a network DN system, referred to as a Space Based Augmentation System (SBAS). Shown are the rover 170 and four representative base stations 140A-140D. The rover 170 includes the antenna 174 and the navigation receiver 172. The base station 140A includes the navigation receiver 142A, the antenna 141A, and the data processing and communications unit 146A; base station 140B-base station 140D are each similar to the base station 140A. In general, the rover and each base station can receive navigation signals from a slightly different subset of navigation satellites in the constellation 102 due to varying conditions in different locations. Operation of the rover in a differential mode is possible, however, only using satellite signals received simultaneously by the rover 170 and by the base stations 140A-140D.

Base stations 140A-140D transmit data 143A-143D, respectively, to the network control center (NCC) 150. The data can be transmitted via communications links or via a communications network, e.g., Internet. The NCC 150 includes the communication module 152, data processing unit 154, satellite transmitter 156, and uplink antenna 158. The NCC 150 receives the data from the base stations via the communication module 152 and processes the data according to specific algorithms with help of data processing unit 154 to generate a consolidated set of correction data (described in more detail below). The NCC 150 transmits the consolidated set of correction data to the geosynchronous (geostationary) relay satellite 160 via the satellite uplink channel 151 with help of the satellite transmitter 156, and the uplink antenna 158.

The geosynchronous relay satellite 160 then retransmits the consolidated set of correction data over a specific region (zone) of the Earth. Multiple geosynchronous relay satellites provide coverage for multiple zones. In FIG. 1C, the rover 170 receives the consolidated set of error correction data from the geosynchronous relay satellite 160 via the satellite signal 161. The rover 170 then calculates its position from the navigation signals and the consolidated set of correction data. Note that the navigation receiver 172 in the rover 170 needs to be specially equipped and programmed to process the satellite signal 161.

The consolidated set of correction data can be divided into several groups. The consolidated set of correction data can include:
Corrections to code phase measurements from one or more individual base stations in a group of base stations;
Corrections to both code phase and carrier phase measurements from one or more individual base stations in a group of base stations;
Corrections to orbital (trajectory) parameters and clock parameters of GNSS satellites, specified in the processing of measurements from a group of base stations;
Corrections to code phase measurements for a some virtual (i.e., non-existent) base station generated from processing GNSS measurements for a group of base stations;
Corrections to code phase and carrier phase measurements for a virtual base station generated from processing GNSS measurements collected with a group of base stations; and
Auxiliary information, like ionosphere data, evaluated hardware-induced biases, network ID, textual information on hardware or software of service provider, etc.

A third example of a network DN system, referred to as Precise Point Positioning (PPP), is similar to network RTK in some aspects, but correction data is presented differently. The architecture of the PPP system is identical to that of the SBAS. Referring to FIG. 1C, a PPP system includes a network of base stations 140A-140D distributed regionally or globally. They send their data to the network control center (NCC) 150. The NCC 150 receives the data from the base stations and processes the data according to specific algorithms to generate a consolidated set of error correction data (described in more detail below). As one option, the NCC 150 can transmit the consolidated set of error correction data to the geosynchronous (geostationary) relay satellite 160 via the satellite uplink channel 151. In another option, the NCC 150 can make the consolidated set of error correction data available to a rover via the Internet.

The key distinction between the PPP system and the typical SBAS, despite similarity in infrastructure, is different accuracy. The SBAS can provide position accuracy on the order of a meter or better; whereas, the PPP system is capable of delivering decimeter level position accuracy. In certain cases, PPP correction data sets can make possible carrier phase ambiguity resolution, thus leading to centimeter level position accuracy (similar to RTK).

The consolidated set of error correction data in a PPP system can be partitioned into several groups. The consolidated set of error correction data can include:
Corrections to orbital (trajectory) parameters of GNSS satellites specified in the processing of measurements from a group of base stations;
Corrections to clock parameters of GNSS satellites, specified in the processing of measurements from a group of base stations;
Corrections for residual uncompensated errors of GNSS measurements; and
Auxiliary information, like ionosphere data, evaluated hardware-induced biases, network ID, textual information on hardware or software of service provider, etc.

Each navigation satellite in a global navigation satellite system can transmit navigation signals in one or more frequency bands (for example, in the L1, L2, and L5 frequency bands). To simplify the terminology herein, a navigation receiver is also referred to simply as a receiver. A single-band receiver receives and processes signals in one frequency band (such as L1); a multi-band receiver receives and processes signals in two or more frequency bands (such as L1, L2, and L5). A single-system receiver receives and processes signals from a single GNSS (such as GPS); a multi-system receiver receives and process signals from two or more GNSSs (such as GPS, GLONASS, and GALILEO). See generally rfwireless-world.com/Terminology/GPS-Frequency-Band-and-GNSS-Frequency-Band.html, incorporated by reference herein in its entirety, regarding the GNSS frequency bands.

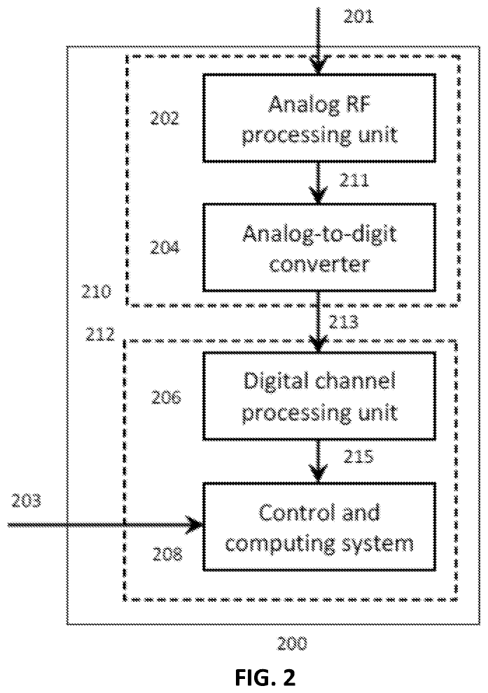

FIG. 2 shows a high-level schematic functional block diagram of embodiment of a receiver 200. The input analog signal 201 represents the total signal (also referred to as the combined signal, aggregate signal, or composite signal) of all the navigation signals received by the antenna (not shown) coupled to the receiver 200. For the example shown in FIG. 1A, the input analog signal 201 includes the navigation signals 103A-103F. The input analog signal 201 is first inputted into the analog radio frequency (RF) processing unit 202. In the analog RF processing unit 202, the input analog signal 201 is filtered with a bandpass filter, centered at the frequency of navigation signals (e.g., 1575.42 MHz), and amplified by a low-noise amplifier, which might have different parameters, for example, a gain of 50 dB, and a noise figure of, for example, 4.0 dB. After that, a signal is mixed with the signal 217 of the local frequency oscillator 216 and passed through a series of filters to transform it into a signal at intermediate frequency of, for example, 47.74 MHz. This transformed signal is denoted as the output analog signal 211.

The output analog signal 211 is input into the analog-to-digit converter (ADC) 204, which digitizes the analog signal 211. The combination of analog RF processing unit (202) and ADC (204) is commonly referred to as radio-frequency (RF) front-end (210).

The output digital signal 213 is then input into the digital channel processing unit 206, which performs signal search, acquisition and tracking in order to generate raw measurement data, based on signal 217 of the frequency oscillator 216. The raw measurement data, besides code phase and carrier phase measurements, includes GNSS information encoded on the navigation signals (such as satellite ephemeris and satellite clock parameters). The output digital signal 215 is input into the control and computing system 208, which computes target parameters such as position, velocity, and time offset.

The combination of digital channel processing unit (206) and control and computing system (208) is commonly referred to as a receiver digital section (212).

If the receiver operates in a differential navigation mode, the control and computing system 208 receives the correction data 203, used to compute target parameters with better accuracy. In the single-base-station DN system shown in FIG. 1A, the error correction data 203 would be received from the communications transceiver 126 in the rover 120. In the network DN system shown in FIG. 1B, the error correction data would be received from the communications transceiver 196 in the rover 190. In the network DN system shown in FIG. 1C, the error correction data 203 would be received from the satellite signal 161.

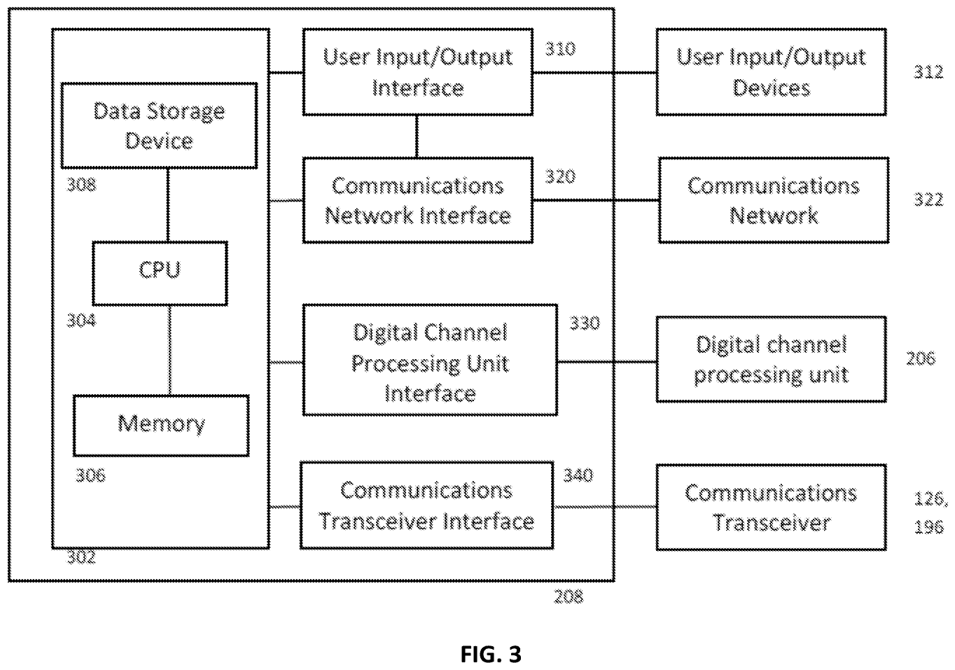

An embodiment of the control and computing system 208 is shown in FIG. 3. One skilled in the art can construct the control and computing system 208 from various combinations of hardware, firmware, and software. One skilled in the art can construct the control and computing system 208 from various electronic components, including one or more general purpose processors (such as microprocessors), one or more digital signal processors, one or more application-specific integrated circuits (ASICs), and one or more field-programmable gate arrays (FPGAs), and/or discrete components.

The control and computing system 208 includes a computer 302, which includes a processor (referred to as the central processing unit (CPU)) 304, memory 306, and a data storage device 308. The data storage device 308 includes at least one persistent, non-transitory, tangible computer readable medium, such as non-volatile semiconductor memory, a magnetic hard drive, or a compact disc read only memory.

The control and computing system 208 further includes a user input/output interface 310, which interfaces the computer 302 to user input/output devices 312. Examples of user input/output devices 312 include a keyboard, a mouse, a local access terminal, and a video display. Data, including computer executable code, can be transferred to and from the computer 302 via the user input/output interface 310.

The control and computing system 208 further includes a communications network interface 320, which interfaces the computer 302 with a communications network 322. Examples of the communications network 322 include a local area network and a wide area network. A user can access the computer 302 via a remote access terminal (not shown) communicating with the communications network 322. Data, including computer executable code, can be transferred to and from the computer 302 via the communications network interface 320.

The control and computing system 208 further includes a digital channel processing unit interface 330, which interfaces the computer 302 with the digital channel processing unit 206 (see FIG. 2).

The control and computing system 208 further includes a communications transceiver interface 340, which interfaces the computer 302 with a communications transceiver, such as the communications transceiver 126 (see FIG. 1A) or the communications transceiver 196 (see FIG. 1B).

As is well known, a computer operates under control of computer software, which defines the overall operation of the computer and applications. The CPU 304 controls the overall operation of the computer and applications by executing computer program instructions that define the overall operation and applications. The computer program instructions can be stored in the data storage device 308 and loaded into the memory 306 when execution of the program instructions is desired. The algorithms described below can be defined by computer program instructions stored in the memory 306 or in the data storage device 308 (or in a combination of the memory 306 and the data storage device 308) and controlled by the CPU 304 executing the computer program instructions. For example, the computer program instructions can be implemented as computer executable code programmed by one skilled in the art to perform algorithms. Accordingly, by executing the computer program instructions, the CPU 304 executes the algorithms described below.

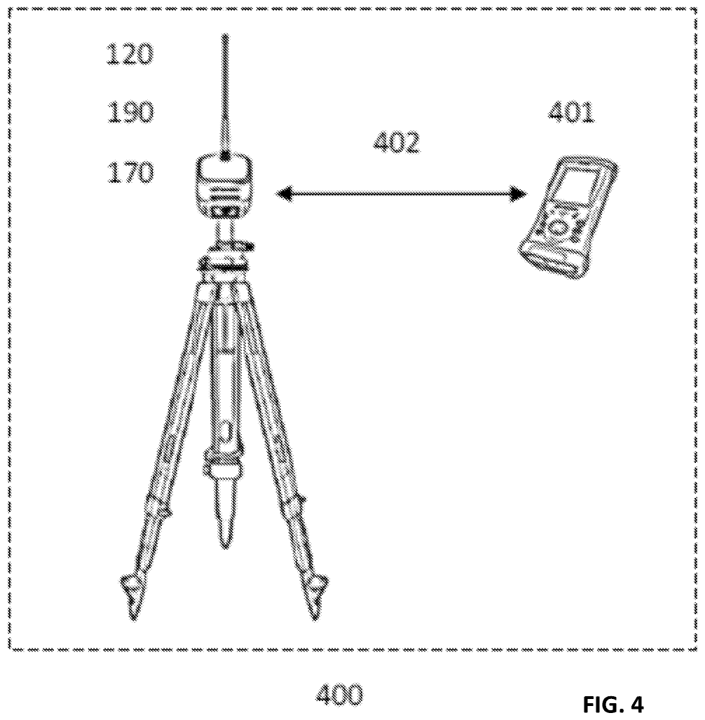

FIG. 4 shows an embodiment of a system 400, where the invention described herein is be used. The system includes a receiver 120, 190, or 170 installed over a static point, a mobile computing device 401, and an interface 402 connecting the receiver with a mobile computing device. One skilled in the art can compose a system 400 of different components in place of items 401 and 402. In one embodiment, the mobile computing device 401 is specifically designed ruggedized filed controller. In another embodiment, it is a notebook. In a third embodiment the device 401 is represented with a tablet or a smartphone.

One skilled in the art can run the unit 401 in FIG. 4 under various operating systems (OS). In one embodiment, it is WINDOWS OS of any version. In another embodiment, it is ANDROID OS. In a third embodiment the device 401 can be run under IOS or LINUX.

One skilled in the art can use different communication interfaces 402 to communicate between the GNSS receiver and a mobile computing device 401. In one embodiment, this is serial RS-232/RS-432 cabled connection. In another embodiment, this is USB cabled connection. In the third embodiment, the communication interface 402 is represented with the BLUETOOTH, or WI-FI wireless data link.

To compute the position with the best achievable accuracy, RTK algorithms are used. The main problem of any RTK algorithm is resolving integer carrier phase ambiguities. The success of this process is dependent on GNSS satellite geometry and measurement errors. Success here means that ambiguities are resolved to correct integers. If ambiguities are resolved correctly, carrier phases with extracted ambiguities are used to compute the solution, and this solution will have the accuracy of several centimeters or better.

The first step of data processing, preceding ambiguity resolution (AR) is differencing base and rover measurements. This process if commonly referred to as the “single-differencing”.

ΔC^{j}=C_{B}^{j}−C_{R}^{j}=R_{B}^{j}−R_{R}^{j}+ΔT^{j}+ΔI^{j}+Δe^{j}+Δτ^{j}B_{C}+Δξ^{j} (1)

ΔP^{j}=P_{B}^{j}−P_{R}^{j}=R_{B}^{j}−R_{R}^{j}+ΔT^{j}−ΔI^{j}+Δe^{j}+Δτ^{j}B_{P}+ΔN^{j}×λ^{j}+Δη^{j} (2)
where:
Δ— differencing operator
j—index of GNSS satellite
C_{B}^{j},C_{R}^{j}—code phase pseudo-range measurements made at base and rover respectively, with j-th GNSS satellite
P_{B}^{j}, P_{R}^{j}—carrier phase pseudo-range measurements made at base and rover respectively, with j-th GNSS satellite
R_{B}^{j},R_{R}^{j}—true distances between base and the j-th GNSS satellite, and rover and the j-th GNSS satellite respectively
ΔT^{j}—difference of signal delays due to troposphere between base and rover with respect to j-th GNSS satellite
ΔI^{j}—difference of signal delays due to ionosphere between base and rover with respect to j-th GNSS satellite
Δe^{j}—difference of GNSS ephemeris errors projections onto distances between base and the j-th GNSS satellite, and rover and the j-th GNSS satellite
Δτ^{j}—difference of GNSS clock error impacts onto distances between base and the j-th GNSS satellite, and rover and the j-th GNSS satellite
B_{C}—various biases common for code phase measurement difference of all GNSS satellites (including difference of receiver clock offsets between base and rover)
B_{P}—various biases common for carrier phase measurement difference of all GNSS satellites (including difference of receiver clock offsets between base and rover)
ΔN^{j}—difference of carrier phase ambiguities between measurements made at base and rover with the j-th GNSS satellite
λ^{j}—wavelength of carrier phase measurements of the j-th GNSS satellite
Δξ^{j}— difference of code noise and code multipath errors
Δη^{j}—difference of carrier noise and carrier multipath errors

As result of single-differencing mutual errors of base and rover cancel out, being correlated. In fact, if the correlation is strong enough (which basically holds true for short baselines) equations (1) and (2) for single differences can be re-written as follows:

ΔC^{j}=C_{B}^{j}−C_{R}^{j}=R_{B}^{j}−R_{R}^{j}+B_{C}+Δξ^{j} (3)

ΔP^{j}=P_{B}^{j}−P_{R}^{j}=R_{B}^{j}−R_{R}^{j}+B_{P}+ΔN^{j}×λ^{j}+Δη^{j} (4)

However, the longer the distance, the less correlated measurements are between base and rover. This leads to appearance of additional biases in equations (3) and (4), which results in equations (5) and (6) below:

ΔC^{j}=C_{B}^{j}−C_{R}^{j}=R_{B}^{j}−R_{R}^{j}+B_{C}+b_{c}^{j}+Δξ^{j} (5)

ΔP^{j}=P_{B}^{j}−P_{R}^{j}=R_{B}^{j}−R_{R}^{j}+B_{P}+ΔN^{j}×λ^{j}+bₚ^{j}+Δη^{j} (6)

where:
b_{c}^{j} and bₚ^{j}—code and carrier biases respectively

When equations (3) and (4) are solved within an equation system, the unknowns, basically, are
x, y, z—coordinates of rover with respect to position of base in any of the reference frames;
B_{C}, B_{P}—biases in code phase and carrier phase measurement differences respectively, common for all GNSS satellites at this instant of time;
ΔN—vector of carrier phase ambiguities single differences.

Within the single-difference approach, biases B_{C}, B_{P} are to be evaluated as additional unknowns, while b_{c}^{j} and bₚ^{j} are the disturbing factors, reducing the performance of the algorithm.

One skilled in the art might suggest various approaches to resolving carrier phase ambiguities and determining the x, y, z—coordinates of rover. The most common one is based on generating double differences to cancel out bias terms B_{C} and B_{P}. While generating double differences one of GNSS satellites is selected as the reference one.

Imagine that the k-th GNSS satellite was chosen as the reference, then, equations (5) and (6) for any j-th GNSS satellite are transformed to the following:

∇ΔC^{k,j}=C_{B}^{k}−C_{R}^{k}−C_{B}^{j}+C_{R}^{j}=R_{B}^{k}−R_{R}^{k}−R_{B}^{j}+R_{R}^{j}+b_{c}^{k}−b_{c}^{j}+Δξ^{k}−Δξ^{j}==∇ΔR^{k,j}+∇Δb_{c}^{k,j}+∇Δξ^{k,j} (7)

∇ΔP^{k,j}=P_{B}^{k}−P_{R}^{k}−P_{B}^{j}+P_{R}^{j}=R_{B}^{k}−R_{R}^{k}−R_{B}^{j}+R_{R}^{j}+ΔNₖ×λ^{k}−ΔN^{j}×λ^{j}+bₚ^{k}−bₚ^{k}+Δη^{k}−Δη^{j}=∇ΔR^{k,j}+∇ΔN^{k,j}×λ+∇Δb_{P}^{k,j}+∇Δη^{k,j} (8)
where:
∇Δ—double difference operator;
λ^{k}=λ^{j}=λ for GNSS with code division multiple access (CDMA).

The task of AR is to evaluate integer values of ∇ΔN^{k,j}. One skilled in the art might consider different ways to achieve AR. The most widely known method is described in “The LAMBDA Method for Integer Ambiguity Estimation: Implementation Aspects”, by Paul de Jonge and Christian Tiberius, published by LGR-Series Publications of the Delft Geodetic Computing Centre No. 12.

Within a typical AR algorithm, the following steps are present, though one skilled in the art can build this algorithm differently:
generating double differences between base and rover code phase and carrier phase measurements, choosing one of the satellites as the reference (as per equations 7 and 8);
evaluating carrier phase ambiguities of differenced measurements as floating point values (“float ambiguities”);
evaluating carrier phase ambiguities of differenced measurements as integer values and forming sets of ambiguities to be checked for optimality;
checking integer ambiguity sets in order to come to conclusion if this is the optimum set, i.e., one which is capable to provide the most accurate position;
if the ambiguity set passes certain criteria, it can be used for positioning, such ambiguities are called “fixed ambiguities”;
upon finding the optimum integer ambiguity set (i.e., fixing, or, resolving ambiguities)—excluding these integers out of carrier phase measurement differences, thus correcting them;
generating position estimates with carrier phase differences, corrected for fixed ambiguities;
with every new measurement set—checking fixed ambiguities for optimality, and if optimality check fails—attempting to resolve ambiguities anew.

If the positioning solution is achieved with fixed ambiguities, this solution is called a ‘fixed’ solution. This implies that position is estimated with the best accuracy.

Various fix criteria are known in the art for choosing the proper carrier phase ambiguity set. The most widely used are the minimum of the quadratic form for ambiguities, and a “Contrast Ratio” (see, e.g., D. Milyutin and A. Plenkin, US Patent Application Publication No. 2011/0115669, entitled “Detection and Correction of Anomalous Measurements and Ambiguity Resolution in a Global Navigation Satellite System”). One skilled in the art can also use other criteria.

The minimum of the quadratic form criteria is based on analysis of the value computed according to the following formula:

q=(M−\tilde{M})^{T}D(M−\tilde{M}) (9)
where
q—quadratic form value
\tilde{M}—float ambiguities vector, estimated in the process of ambiguity resolution
M—candidate integer ambiguities vector
D—information matrix obtained as result of Z-transformation of covariance matrix of ambiguities

Among various ambiguity sets, those two are selected that form the minimum value of q (i.e., q1), and the second minimum value of q (i.e., q2). They are both used to form a “Contrast Ratio”:

C=q2/q1 (10)

The “Contrast Ratio” criterion is based on an assumption that if the value of C is larger than a predefined threshold, the ambiguity set used to form q1 can be treated as the optimum one, the ambiguity resolution is finished, and resolved ambiguities can be used to generate the final solution. If the value of C is less than or equal to a predefined threshold, the process of ambiguity resolution continues.

Ambiguity resolution process is often not instantaneous, and it can take more than one measurement epochs to come to a reliable conclusion on the optimality of the candidate measurement set, especially, if observation conditions are challenging.

In certain cases, the criteria (9) and (10) could lead to incorrect results, that is, taking the wrong ambiguity set as the optimum one. In such cases, positioning errors might be on the order of few meters or more, while centimeter-level errors are expected. Such situations are called wrong ambiguity resolutions. A solution, which is computed with a wrong ambiguity set, is often referred to as an “outlier”.

The less time is required to resolve the ambiguities, and the fewer outliers are output, the more efficient, and the more reliable the process of AR is. Different factors affect time to resolution and the reliability of AR.

First, time to resolution and the reliability of AR depend on the value of biases present in “base-minus-rover” differences Δb_{c}^{j} and Δbₚ^{j} (as per equations 5 and 6), or ∇Δb_{c}^{k,j} and ∇Δbₚ^{k,j} (as per equations 7 and 8).

Second, increased carrier phase noise and multipath (Δη^{j} and ∇Δη^{k,j}) could lead to a longer time to resolution and less reliable AR.

Third, if a number of available satellite measurements is reduced due to signal blocking or interference, this could lead to the fact that a system of equations (6) or (8) is poorly determined, resulting in a longer time to resolution and a less reliable AR.

The process of determining the positions in geodesy and cartography is often referred to as geodetic or topographic survey. In order to make a survey, a plurality of locations are chosen, called checkpoints, whose positions need to be surveyed.

In order to improve the quality of survey, a method of occupations is used, that is visiting the same checkpoint several times, divided by a certain interval. Staying at the same checkpoint with the purpose of collecting data is called “occupation.” When a surveyor returns back to the same checkpoint in order to repeatedly collect data, this is treated as another occupation of the same checkpoint.

During the process of occupation, GNSS receiver might function either in raw data collection mode, or in any of the positioning modes, typically in RTK, which is the most precise.

The subject of the current invention and the description hereinafter is a method for conducting occupations in any of the positioning modes, and as an example, RTK is used.

Positions of the same checkpoint, surveyed in different occupations are compared to each other; those that match are used for computing the combined coordinates of the checkpoint. The mismatched positions are discarded.

Some checkpoints might be located in challenging conditions e.g., close to a wall, or under tree canopy, and several occupations are often required to survey them reliably.

The method of occupations is typically implemented as follows (referring to FIG. 4):
a receiver 120, 190, or 170, installed over a static point is controlled with a mobile computing device 401 via communication interface 402;
an operator uses mobile computing device 401 to communicate with the receiver and perform a survey, that is tuning the receiver, setting up the duration of each occupation and accuracy criteria for the survey, logging the survey results;
after several points are surveyed, a mobile computing device 401 might be used to sketch a local map and perform some additional processing like traverse, or network adjustment, etc.

Unfortunately, the typical approach to survey with occupations might provide poor accuracy in challenging environments, as wrong AR might go undetected in RTK mode, so that the whole occupation might be recorded with incorrectly resolved ambiguities. This might be discovered during the next occupation, by means of comparing the results of two occupations, but there is no guarantee that the next occupation will be with correct AR, taking into account that conditions for that checkpoint are challenging.

The object is therefore improving the quality of surveying using the method of occupations, with the aim of providing robust occupation results, free of errors due to incorrect AR, so as to avoid a need for repeated occupation of the same checkpoint.

A method is proposed, which, when implemented in the form of software routine, can be used within a mobile computing device 401.

The proposed method divides a single occupation into sessions. Coordinates of a checkpoint are evaluated independently in every session within a single occupation, and then, coordinate solutions are checked for consistency, that is, that they have their scatter within specified margins.

The whole session is named internally consistent, if it contains consistent solutions.

If a required number of internally consistent sessions is reached, they should be checked for mutual consistency between session results.

If the required number of mutually consistent sessions is reached, their results are processed to compute a single solution for a given occupation, which is the aim of the method.

If the required number of mutually consistent sessions is not reached, more coordinate solutions should be collected to generate more internally consistent sessions to be checked for mutual consistency. The detailed description of the suggested method follows.

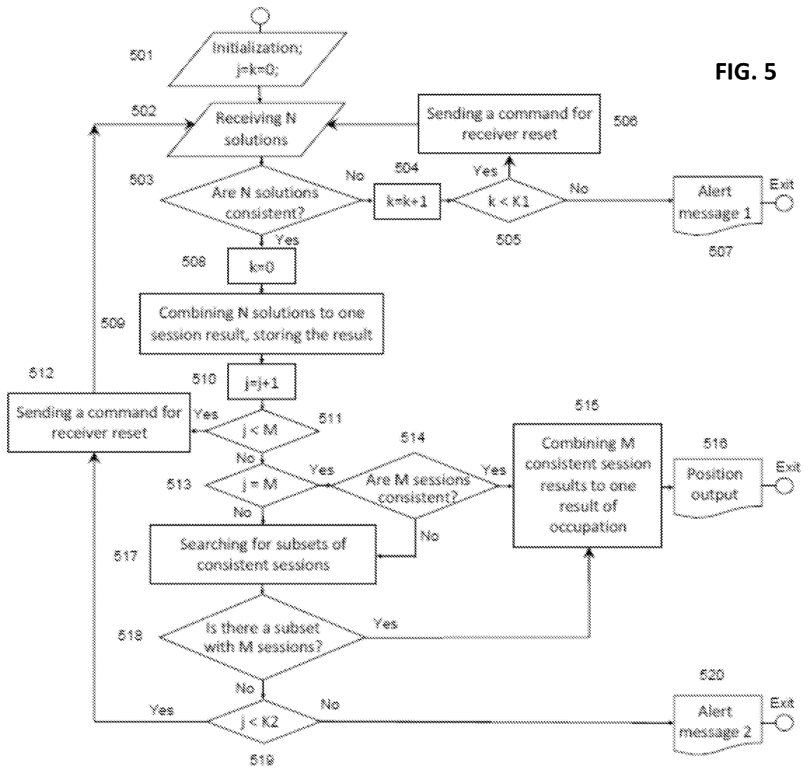

Referring to FIG. 5, at a first step a GNSS receiver should be properly initialized and instructed to track the desired GNSS signals with relevant masks on elevation and signal-to-noise ratio, store needed data, receive differential corrections etc., and to output a coordinate solution, computed in a proper mode, to a mobile computing device 401.

At step 501 the routine is initialized with the following values:
N—number of consecutive solutions to be used to compute coordinates of a check point within a single session; N>1;
K1—maximum number of attempts to quit a routine, if N internally consistent solutions are not found within a session;
M—minimum number of internally consistent sessions, results of which should be found to be mutually consistent; M>1;
K2—maximum number of internally consistent sessions to quit a routine, if M mutually consistent sessions are not found; K2≥M;
T1—a threshold for consistency check, which is a bound for three-dimensional coordinate difference of solutions computed within a single session;
T2—a threshold for consistency check, which is a bound for three-dimensional coordinate difference of results, computed in different sessions within a single occupation.

Additionally, let us introduce:
i—counter of solutions within a single session; i∈[1; N];
k—counter of sequential attempts to make an internally consistent session;
k∈[1; K1];
j—counter of sessions; j∈[1; K2].

At step 502 N consecutive solutions are acquired from the receiver, and checked for internal consistency at step 503. One skilled in the art can offer various approaches to such a consistency check. One of the methods is described below. It is based on evaluating the maximum solution separation.

As such, at step 503, one of the solutions out of N is chosen as the reference one. Various criteria might be applied to choosing the reference solutions. One skilled in the art might suggest choosing the solution with the best PDOP, or smallest error covariance evaluations, or to average all the solution and take the averaged solution as the reference one. Let us for simplicity choose the first solution as the reference one, and compute a set of distances between the solutions:

D₁₋ᵢ=\sqrt{(X₁−Xᵢ)²+(Y₁−Yᵢ)²+(Z₁−Zᵢ)²} (11)
where
i=[2; N];
X₁; Y₁; Z₁—coordinates of the reference solution
Xᵢ; Yᵢ; Zᵢ— coordinates of the i-th solution

Then, at step 503, the maximum solution separation is determined and compared with a threshold:

max D₁₋ᵢ≥T1 (12)

i∈[2;N]

If the relationship (12) holds true at step 503, then the current session is admitted as internally consistent, and a relevant counter of attempts is reset at step 508.

If the relationship (12) is false, a counter of attempts to make an internally consistent session is incremented at step 504, and compared with a threshold K1 at step 505.

If the condition k<K1 is met at step 505, then, at step 506, a set of commands is sent to GNSS receiver, which fully or partially resets its RTK algorithms and tracking channels. One skilled in the art might suggest resetting either RTK algorithms only, or tracking channels only, or to avoid the resetting at all. However, resetting is desirable as it makes the results of each session statistically independent from the results of other sessions. After resetting, control goes back to step 502.

If the condition k<K1 is not met at step 505, this means that existing operation environment does not allow for robust positioning and an alert message #1 should be issued to a customer. For example, the message might say: “Solution Internal Consistency is not Reached”.

Upon receiving an alert message #1 a user might want to either leave this checkpoint and visit it another time, or resume a survey with different values of N, K1, T1.

After step 508, control goes to step 509, where combined solution for the current session is generated. One skilled in the art can offer various approaches to generating a combined solution, but one of the most efficient ones is believed to be weighted average. Equations (13) and (14) below describe generating weighted average for the X-component of the coordinate solution, while weighted average for the Y-component, or the Z-component of the coordinate solution is generated identically:

$${\overline{X}}_{j} = \frac{{\sum }_{i = 1}^{N} {X}_{i} \times {Px}_{i}}{\overline{P} {x}_{j}} \qquad ( 13 )$$

$$\overline{P} {x}_{j} = {\sum }_{i = 1}^{N} {Px}_{i} \qquad ( 14 )$$

where
Xᵢ—the component of the i-th coordinate solution;
Pxᵢ—the weight of the component of the i-th coordinate solution;
X̅ⱼ—averaged component of the coordinate solution for the j-th session; j∈[1; M]
P̅xⱼ—
the weight of the averaged component of the coordinate solution for the j-th session.

The j-counter of internally consistent sessions is incremented at step 510 and compared with a threshold M at step 511.

If condition j<M is met at step 511, the control goes to step 512, otherwise, to step 513.

At step 512 a set of commands is send to GNSS receiver, which fully or partially resets its RTK algorithms and tracking channels. Then, control goes back to step 502.

At step 513, if condition j=M is met, control goes to step 514, otherwise to step 517.

At step 514, results of first M sessions are checked for mutual consistency. One skilled in the art can offer various approaches to such a consistency check. One of the exemplary approaches based on the use of T2 threshold will be described further in the text.

If the first M sessions are found to be mutually consistent, the control goes to step 515, otherwise to step 517.

If M mutually consistent sessions are found, a combined solution for the current occupation is generated at step 515. One skilled in the art can offer various approaches to generating combined solution, but one of the most efficient ones is believed to be weighted average, computed similarly to (13) and (14). Equations (15) and (16) below describe generating weighted average for the X-component of the coordinate solution, while weighted average for the Y-component, or the Z-component of the coordinate solution is generated identically:

$$\hat{X} = \frac{{\sum }_{j = 1}^{M} {\overline{X}}_{j} \times \overline{P} {x}_{j}}{{\hat{P}}_{x}} , \qquad ( 15 )$$

$${\hat{P}}_{x} = {\sum }_{j = 1}^{M} \overline{P} {x}_{j} \qquad ( 16 )$$

where
X̅ⱼ—the solution component of the j-th session;
P̅xⱼ—the weight of the solution component of the j-th session;
\hat{X}—the resulting solution component of the whole occupation;
\hat{P}ₓ—the weight of the resulting solution component of the whole occupation.

After the resulting solution of the occupation is generated at step 515, it is stored in the file or, output to a monitor, or to a communication interface, or similar, at step 516, and the process of surveying a checkpoint is finished.

If control comes to step 517, this means that the first M sessions have not been found to be mutually consistent, and subsets of mutually consistent sessions should be searched for. One skilled in the art can offer various approaches to such a search process. One of the exemplary approaches, based on the use of T2 threshold will be described further in the text.

At step 518 subsets of mutually consistent solutions are checked for the number of solutions included into every set. If there is a set, which contains M solutions, control goes to step 515, otherwise to step 519.

At step 519, the j-counter of sessions is checked against a threshold. As such, if the condition j<K2 is met, this means, that one more session should be made, and the control goes to step 512. If not—this means that despite K2 attempts has been made, no M mutually consistent sessions have been found, and the control goes to step 520.

At step 520 an alert message #2 should be issued to the user. For example, the message might say: “Required Number of Mutually Consistent Session Has not been Found”.

Upon receiving an alert message #2 the user might want to either leave this checkpoint and return to it another time, or resume a survey with different values of N, M, K1, K2, T1, T2.

To summarize the description of the FIG. 5, note that the output of the routine should be either a combined solution at step 516, or alert message #1 at step 507, or alert message #2 at step 520.

Further with reference to step 514 of the FIG. 5, it should be noted that the algorithm of determining, whether M sessions are consistent, is identical to one, described by (11) and (12), however X̅ⱼ, Y̅ⱼ, Z̅ⱼ should be used instead of Xᵢ, Yᵢ, Zᵢ, and T2 instead of T1.

Further discussion is needed regarding an algorithm for searching for subsets of mutually consistent sessions at step 518.

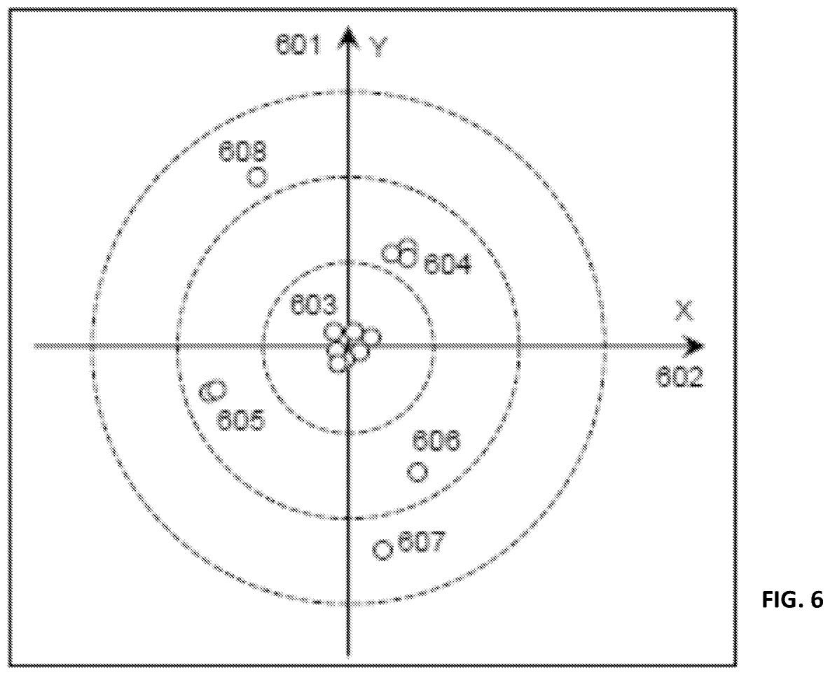

FIG. 6 shows example of session result scatter in horizontal plane, which helps to better convey an idea of searching the subsets of mutually consistent session results. In FIG. 6 the Y-axis 601 is an axis passed from the true position to the North, the X-axis 602 is an axis passed from the true position to the East.

In FIG. 6 there are: a group of session results 603, which contains the biggest number of sessions, several groups with smaller number of sessions—604 and 605, and single sessions 606, 607, 608 clearly outlying from all other groups.

When looking at FIG. 6 it is clear that groups 603, 604, 605 contain mutually consistent results. But, group 603 contains the largest number of consistent results. And, the probability is high, that this group contains the results concentrated over the true position, while other groups do not. That is why, the first group which is getting the required number of mutually consistent sessions can be admitted as the one to be used because it is located over the true position.

Below the method for choosing subsets is described. One skilled in the art can offer alternative methods to achieve the same goal.

Let us assume that at step 518, a W-plurality with w sessions is available. As such, w−1 distances are computed and compared with a threshold T2:

D₁₋ⱼ=\sqrt{(X̅₁−X̅ⱼ)²+(Y̅₁−Y̅ⱼ)²+(Z̅₁−Z̅ⱼ)²} (17)

D₁₋ⱼ≤T2 (18)
where
j=[2; w];
X̅ᵢ, Y̅ᵢ, Z̅ᵢ—coordinates of the first session from W-plurality;
X̅ⱼ, Y̅ⱼ, Z̅ⱼ—coordinates of the j-th session from W-plurality.

If relationship (18) is true, the session results which form D₁₋₄ are treated as consistent and should be grouped into plurality Q1 with q1-quantity of sessions. Those results that do not satisfy (18) are treated as inconsistent and should be grouped into plurality R1 with r1-quantity of sessions.

If it turns out that q1=0, and r1=w, then a session with X̅₁, Y̅₁, Z̅₁ is an outlying session, it should be excluded from R1, and r1 should be decreased by one.

If a number of sessions in R1 is more than 1 (i.e., if r1>1), new search should be made:

D₁₋ⱼ=\sqrt{(X̅₁−X̅ⱼ)²+(Y̅₁−Y̅ⱼ)²+(Z̅₁−Z̅ⱼ)²} (19)

D₁₋ⱼ≤T2 (20)
where
j=[2; r1];
X̅₁, Y̅₁, Z̅₁—coordinates of the first session from R1-plurality
X̅ⱼ, Y̅ⱼ, Z̅ⱼ—coordinates of the j-th session from R1-plurality

If relationship (20) is true, the results that form D₁₋ⱼ are treated as consistent and should be grouped into plurality Q2 with q2-quantity of sessions. Those results which do not satisfy (20) are treated as inconsistent and should be grouped into plurality R2 with r2-quantity of sessions.

If q2=0, and r2=r1 than a session with X̅₁, Y̅₁, Z̅₁ is an outlying session, it should be excluded from R2, and r2 should be decreased by one.

If a number of sessions in R2 is more than 1, new search should be made similarly to (18) and (20) to determine a new plurality of consistent sessions Q3 with q3-quantity of sessions, and a new plurality of inconsistent sessions R3 with a r3-quantity of sessions.

This search process should repeat until all w sessions are attributed either to different pluralities of consistent sessions, or to outlying sessions.

Having thus described a preferred embodiment, it should be apparent to those skilled in the art that certain advantages of the described method and system have been achieved. It should also be appreciated that various modifications, adaptations, and alternative embodiments thereof may be made within the scope and spirit of the present invention. The invention is further defined by the following claims.

What is claimed is:

1. A method for surveying a position of a static point using a global navigation satellite systems (GNSS) receiver, comprising:
(i) accepting from GNSS receiver at least two estimates of the position of the static point in a single session;
(ii) combining the at least two estimates from (i) into a single session result;
(iii) resetting a GNSS receiver, including any of: resetting tracking loops for all satellites or for selected satellites, resetting tracking loops for all frequencies or for selected frequencies, resetting filters in positioning algorithms, and resetting smoothing loops in positioning algorithms;
(iv) repeating (i)-(iii) at least one more time;
(v) checking results of multiple sessions for consistency by testing if their scatter is within a specified margin;
(vi) upon finding at least two consistent session results, combining the consistent session results into a final position estimate of the static point; and
(vii) if there is an insufficient number of consistent session results, repeating (i)-(vi) until at least two consistent session results are found.

2. The method of claim 1, wherein the checking in (v) stops, if at least two consistent session results are not found after a predefined number of attempts.

3. The method of claim 2, further comprising issuing an alert message to a user, if at least two consistent session results are not found after a predefined number of attempts.

4. The method of claim 1, further comprising, prior to the combining in (ii), checking estimates for consistency by testing if their scatter is within a specified margin, so that only consistent estimates are used in (ii).

5. The method of claim 4, wherein finding a required number of consistent estimates forming the session result stops if a required number of consistent estimates is not found after a predefined number of attempts.

6. The method of claim 4, further comprising issuing an alert message to a user if a predetermined number of consistent estimates is not found after a predefined number of attempts.

7. The method of claim 1, wherein the combining in (ii) uses a weighted average.

8. The method of claim 1, wherein the combining in (vi) uses a weighted average.

9. The method of claim 1, wherein the estimates are based on use of real-time kinematics (RTK).

10. An apparatus for surveying a position of a static point using a global navigation satellite systems (GNSS) receiver and a mobile computing device, connected to the GNSS receiver, wherein the mobile computing device:
(i) accepts from GNSS receiver at least two estimates of the position of the static point in a single session;
(ii) combines the at least two estimates from (i) into a single session result;
(iii) resets tracking loops for all satellites or for selected satellites, resets tracking loops for all frequencies or for selected frequencies, resets filters in positioning algorithms, and/or resets smoothing loops in positioning algorithms;
(iv) repeats (i)-(iii) at least one more time;
(v) checks results of multiple sessions for consistency by testing if their scatter is within a specified margin;
(vi) upon finding at least two consistent session results, combines the consistent session results into a final position estimate of the static point; and
(vii) if there is an insufficient number of consistent session results, repeats (i)-(vi) until at least two consistent session results are found.

11. The apparatus of claim 10, wherein a mobile computing device is any of a ruggedized field controller, a notebook, a smartphone and a tablet.

12. The apparatus of claim 10, further comprising a communication interface between the GNSS receiver and a mobile computing device, wherein the interface is any of RS-232/RS-432 cable connection, USB cable connection, Ethernet cable connection, a BLUETOOTH wireless data link, a WI-FI wireless data link.

13. The apparatus of claim 10, wherein the checking in (v) stops after a user-defined number of consistent session results is not found.

14. The apparatus of claim 13, further comprising means for issuing an alert message to the user.

15. The apparatus of claim 10, wherein, prior to the combining in (ii), the system checks estimates for consistency by testing if their scatter is within a specified margin, so that only consistent estimates are used in (ii).

16. The apparatus of claim 15, wherein the accepting and combining in (i) and (ii) stops when a user-defined number of attempts are performed.
